(19) United States
(12) Patent Application Publication
(10) Pub. No.: US 2023/0416533 A1
(43) Pub. Date: Dec. 28, 2023

(54) FOREST RESIDUE BASED RIGID FOAM PRODUCTS AND PROCESSES OF MANUFACTURE

(71) Applicant: PLANTEE BIOPLASTICS INC., VANCOUVER (CA)

(72) Inventors: PRAPHULLA ., VANCOUVER (CA); RICHARD CHEN, VANCOUVER (CA)

(73) Assignee: PLANTEE BIOPLASTICS INC., VANCOUVER, BC (CA)

(21) Appl. No.: 18/247,480

(22) PCT Filed: Oct. 7, 2021
(86) PCT No.: PCT/CA2021/051413

§ 371 Date: Mar. 31, 2023

Related U.S. Application Data
(60) Provisional application No. 63/089,048, filed on Oct. 8, 2020.

(51) Int. Cl. C08L 97/02; C08J 9/00; C08J 9/28; C08J 9/06; C08J 9/30

(52) U.S. Cl. CPC C08L 97/02; C08J 9/0085; C08J 9/286; C08J 9/0061; C08J 9/06; C08J 9/30; C08L 2201/02; C08J 2205/10; C08J 2329/04; C08J 2497/02; C08L 2203/14; C08J 2203/12

(57) ABSTRACT

A process for manufacturing a rigid foam product includes processing a forest residue to obtain fibers having a mesh size of at most 5 mm mesh and an aspect ratio of between 0.5:1 and 20:1; preparing a slurry comprising the fibers, water, a foaming agent, and a polymer additive; foaming the slurry to yield a wet foam; and drying the wet foam to yield a rigid foam product.

### CROSS-REFERENCES TO RELATED APPLICATIONS

This application claims the benefit of and/or priority to U.S. Provisional Patent Application No. 63/089,048 filed on Oct. 8, 2020, which is incorporated herein by reference in its entirety.

### FIELD

This document relates to foams, such as foam insulation used in the construction industry. More specifically, this document relates to forest residue-based rigid foams and foam products, and related processes of manufacture.

### BACKGROUND

United States Patent Application Publication No. US20200308359A1 (Glenn et al.) discloses a composition comprising a fiber component, at least one surfactant/foaming agent, at least one dispersant, and optionally at least one binder. The fiber component forms a viscous mixture that is converted to a foam product upon the addition of the surfactant/foaming agent once the viscous mixture reaches a predetermined dryness. The foam product is resistant to shrinkage during drying and remains rigid.

### SUMMARY

The following summary is intended to introduce the reader to various aspects of the detailed description, but not to define or delimit any invention.

Processes for manufacturing rigid foam products are disclosed. According to some aspects, a process for manufacturing a rigid foam product includes: a. processing a forest residue to obtain fibers having a mesh size of at most 5 mm mesh and an aspect ratio of between 0.5:1 and 20:1; b. preparing a slurry of the fibers, water, a foaming agent, and a polymer additive; c. foaming the slurry to yield a wet foam; and d. drying the wet foam to yield a rigid foam product.

In some examples, the rigid foam product includes at least 60 wt % of the fibers, or at least 70 wt % of the fibers.

In some examples, the size of the fibers is between 1 mm mesh and 5 mm mesh, for example 2 mm mesh.

In some examples, the aspect ratio of the fibers is between 1.5:1 and 12:1, or between 1.7:1 and 11:1.

In some examples, step a. includes grinding the forest residue with at least one of a knife mill, a hammer mill, and a ball mill.

In some examples, step b. includes homogenizing the slurry.

In some examples, step c. includes incorporating air into the slurry. Step c. can include using a froth floatation apparatus.

In some examples, step d. includes heating the wet foam to between 60 degrees Celsius and 90 degrees Celsius. In some examples, step d. includes draining the wet foam. In some examples, the method further includes transferring the wet foam into a mold, and step d. includes drying the wet foam in the mold. In some examples, step d. includes spraying the wet foam onto a surface and drying the wet foam on the surface.

In some examples, the slurry further includes a fire retardant. The fire retardant can include at least one of struvite and sodium bicarbonate.

In some examples, the polymer additive includes at least one of a strengthening agent and a thickening agent. In some examples, the polymer additive includes at least one of polyvinyl alcohol, starch and polyvinyl acetate.

In some examples, the slurry further includes a bio-particle additive, such as at least one of micro fibrillated cellulose (MFC), cellulose nanofibers (CNFs), cellulose nanocrystals (CNCs), and lignin particles.

In some examples, the forest residue includes at least one of pine beetle kill, forest trimmings, and ash borer kills.

In some examples, the foaming agent includes at least one of sodium dodecyl sulfate, sodium stearate, dioctyl sodium sulfosuccinate (DOSS), alkyl-aryl ether phosphates, and linear alkylbenzene sulfonates (LABs).

In some examples, the rigid foam product is a thermal insulation board. In some examples, the rigid foam product is a sprayed foam.

Rigid foam products are also disclosed. According to some aspects, a rigid foam product includes at least 60 wt % of a forest residue fibers having a mesh size of at most 5 mm mesh and an aspect ratio of between 0.5:1 and 20:1; between 0.1 wt % and 15 wt % of a polymer additive; and between 0.1 wt % and 7.5 wt % of a foaming agent. The rigid foam product has a density of between 40 and 150 kg/m³.

In some examples, the rigid foam product includes at least 70 wt % of the forest residue fibers.

In some examples, the rigid foam product includes about 1.5 wt % of the foaming agent.

In some examples, the rigid foam product includes about 3.5% of the polymer additive.

In some examples, the rigid foam product includes between 0.1 wt % and 10 wt % of a fire retardant, for example about 5 wt % of the fire retardant. The fire retardant can be or can include at least one of struvite and sodium bicarbonate.

In some examples, the polymer additive includes at least one of a strengthening agent and a thickening agent. In some examples, the polymer additive includes at least one of polyvinyl alcohol, starch, and polyvinyl acetate.

In some examples, the rigid foam product includes at least one of micro fibrillated cellulose (MFC), cellulose nanofibers (CNFs), cellulose nanocrystals (CNCs), and lignin particles.

In some examples, the forest residue fibers include at least one of pine beetle kill, forest trimmings, and ash borer kills

In some examples, the foaming agent includes at least one of sodium dodecyl sulfate, sodium stearate, dioctyl sodium sulfosuccinate (DOSS), alkyl-aryl ether phosphates, and linear alkylbenzene sulfonates (LABs).

In some examples, the size of the fibers is between 5 mm mesh and 1 mm mesh. For example the size of the fibers can be 2 mm mesh.

In some examples, the aspect ratio of the fibers is between 1.5:1 and 12:1, or between 1.7:1 and 11:1.

In some examples, the rigid foam product is a sprayed foam. In some examples, the rigid foam product is a thermal insulation board.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a flow chart of an example process for manufacturing a foam product.

FIG. 2 shows photographs of a forest residue based rigid foam product. Panel (a) is a photograph of the forest residue based rigid foam products after drying in a silicone mold. Panel 2(b) is a close up photograph showing the foam structure.

FIG. 3 is a stress-strain diagram of the forest residue based rigid foam products and the EPS foam under compressive strain with three compressive regimes: (I) elastic, (II) plateau, and (III) densification.

FIG. 4 shows photographs of recyclability tests. Panel (a) is a photograph of a forest residue based rigid foam product on the water surface. Panel (b) is a photograph of a slurry made after rewetting the forest residue based rigid foam product. Panel (c) shows a wet foam of the rewetted slurry. Panel (d) is a photograph of the foamed rewetted slurry in a silicone mold. Panel (e) is a photograph of recycled forest residue based rigid foam products foams after drying.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

As used herein, the term “about” indicates that a referenced value may vary by plus or minus 5%. For example, a reference to a temperature of “about 60 degrees Celsius” indicates that the temperature may be between 57 degrees Celsius and 63 degrees Celsius.

In this document, unless specified otherwise, all ranges are inclusive of the bounds of the range. For example, the statement that a temperature may be “between 60 degrees Celsius and 90 degrees Celsius” indicates that the temperature may be 60 degrees Celsius, or 90 degrees Celsius, or any number therebetween.

Generally disclosed herein are rigid foams and rigid foam products, such as rigid foam insulation usable in the construction industry (e.g. rigid foam boards or rigid sprayed foam). The rigid foam products disclosed herein are wood-based and can therefore be considered renewable. That is, the rigid foam products disclosed herein are fabricated from wood, such as hard wood, and/or soft wood. In some particular examples, the rigid foam products disclosed herein are fabricated from forest residue (e.g. Canadian derived forest residue or CaDFoR).

As used herein, the term “forest residue” refers to by-products of forest harvesting. Forest residue can include trimmings, cuttings, branches, chips, foliage, roots, small trees, un-merchantable wood, slash from final fellings, slash and small trees from thinnings and cleanings, insect-damaged wood, fire-damaged wood, disease-damaged wood, wood from short rotation wood crops, waste from sawmills, bark, and/or sawdust. Specific non-limiting examples of suitable forest residue include pine beetle infested pine lumber (Beetle Kill), and ash borer kills.

As used herein, the term “rigid” indicates that the foam product holds its shape, and generally resists deformation. For example, rigid foam products may bear some weight and may in some examples be used for structural purposes. This is in contrast to loose, soft mats of fiberglass particles.

The rigid foam products disclosed herein can in some examples have a wood content of at least about 60% by weight, preferably at least about 70% by weight.

The rigid foam products disclosed herein can be biodegradable and/or recyclable. Particularly, the rigid foam products can be broken down mechanically, and then reformed into new rigid foam products of the same or similar quality to the original rigid foam products.

The rigid foam products disclosed herein can have beneficial mechanical properties. For example, the foam products disclosed herein can have high strength and high thermal resistance per unit area (E.g. an R-value of between 5 and 6 per inch).

In some examples, the rigid foam products disclosed herein have similar mechanical and thermal properties to fossil fuel based foams.

The rigid foam products can generally be manufactured by processing a forest residue to obtain fibers; preparing a slurry of the fibers in a liquid, with additives such as a foaming agent and a polymer additive; foaming the slurry to yield a wet foam; and drying the wet foam to yield a rigid foam product.

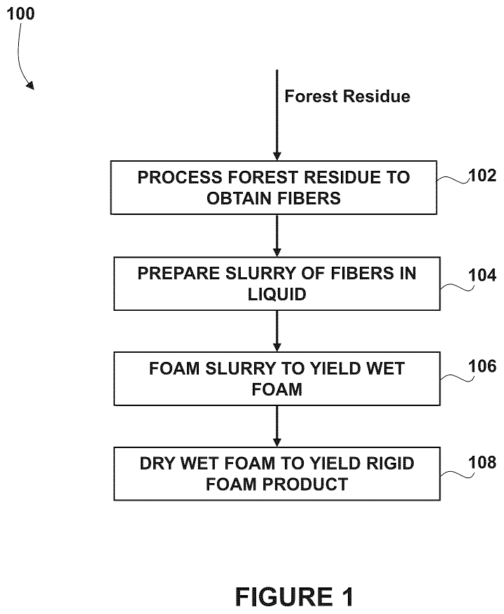

Referring now to FIG. 1, an example process 100 for manufacturing a rigid foam product is shown. At step 102, forest residue is processed to obtain fibers. The forest residue can be processed using a knife mill, a hammer mill, and/or a ball mill. The forest residue can be processed to obtain fibers can have a mesh size of, for example, at most 5 mm mesh, and an aspect ratio (i.e. length:diameter) of between about 0.5:1 and 20:1. Preferably, the mesh size is between 5 mm mesh and 1 mm mesh, and the aspect ratio is between 1.5:1 and 12:1. More preferably, the mesh size is 2 mm (i.e. 10 standard mesh) and the aspect ratio is between 1.7:1 and 11:1. In some specific examples, the fibers can have a length of between about 0.9 mm and 4.5 mm, and a diameter of between about 0.4 mm and 1.2 mm.

At step 104, a slurry of the fibers in a liquid is prepared. The liquid can be or can include, for example, water, ethanol, acetone, or combinations thereof. The slurry can further contain a foaming agent, to facilitate foaming of the slurry. The foaming agent can be or can include a surfactant such as sodium dodecyl sulfate, sodium stearate, dioctyl sodium sulfosuccinate (DOSS), alkyl-aryl ether phosphates, and linear alkylbenzene sulfonates (LABs). The slurry can further contain a polymer additive, such as a strengthening agent and/or a thickening agent. Example polymer additives include polyvinyl alcohol, starch and polyvinyl acetate. The slurry can further contain one or more fire retardants, to impart fire resistant properties to the foam product. The fire retardant can be or can include, for example, struvite, magnesium sulphate, and/or sodium bicarbonate.

The slurry can further optionally contain one or more bio-particle additives, such as micro fibrillated cellulose (MFC), cellulose nanofibers (CNFs), cellulose nanocrystals (CNCs), and lignin particles. The slurry can further optionally contain a heat-activated peroxide cross-linker, for cross-linking the polymer additive to harden the foam.

The slurry can contain, for example, between 0.1 wt % and 90 wt % fibers, between 0.1 wt % and 70 wt % water, between 0.1 wt % and 10 wt % foaming agent, between 0.1 wt % and 5 wt % polymer additive, between about 0.1 wt % and 30 wt % bioparticle additive, and between 0.1 wt % and 5 wt % fire retardant. In one particular example, the slurry can contain about 30 wt % fibers, about 50 wt % water, about 1.5 wt % foaming agent, about 3.5 wt % polymer additive, and about 5 wt % fire retardant.

The slurry can be prepared by dispersing the fibers in the liquid with the additives, and homogenizing the slurry using overhead stirrers and/or mixers.

At step 106, the slurry is foamed to yield a wet foam. For example, the slurry can be foamed by applying shear stress to the slurry and/or bubbling gas into the slurry. In some examples, the slurry is foamed by incorporating air into the slurry using a froth flotation apparatus. In some examples the slurry is foamed using a supercritical blowing agent such as carbon dioxide an/or nitrogen. Mixers and overhead stirrers may also be used to improve air incorporation.

At step 108, the wet foam is dried to yield a rigid foam product. For example, the wet foam can optionally be drained (e.g. on a permeable mesh), then transferred into a mold, and then dried in the mold by applying heat. For example, the wet foam can be heated in an oven to less than about 120 degrees Celsius, such as between about 60 degrees Celsius and about 90 degrees Celsius. In another example, the wet foam can be sprayed onto a surface using pressurized gas, and then dried on the surface (products formed by this method are referred to herein as “sprayed foam”). Alternatively, the wet foam can be dried continuously on a conveyor belt. Alternatively, the wet foam can be dried in a vacuum oven, by profile extrusion, and/or by freeze drying. Optionally, the liquid can be collected and recycled.

The resulting rigid foam product can have a composition of, for example, between 50 wt % and 90 wt % fibers, up to about 10 wt % water, between 0.1 wt % and 7.5 wt % foaming agent, between 0.1 wt % and 15 wt % polymer additive, and between 0.1 wt % and 10 wt % fire retardant. In some particular examples, the rigid foam product can contain about 70 wt % fibers, about 1 wt % water, about 1.5 wt % foaming agent, about 3.5 wt % polymer additive, and about 5 wt % fire retardant.

The rigid foam products can have various uses, e.g. as a thermal insulation board or as a structural panel.

The rigid foam products can be a closed-cell foam or an open cell foam.

The rigid foam products can in some examples have a density of between 40 and 150 kg/m³ (i.e. a similar density to fossil fuel based foams).

The rigid foam products can in some examples have a thermal conductivity of between about 0.01 and about 0.06 W/m×k, for example about 0.042 W/m×K.

The rigid foam products can in some examples have self-extinguishing flame properties and can exhibit no drip of molten material.

The rigid foam products can in some examples have a rigidity that is comparable to or greater than fossil fuel based foams)

The rigid foam products can be produced in a batch, continuous, or semi-continuous process.

Optionally, at the end of the life-cycle of the rigid foam products, the rigid foam products can biodegrade, or can be recycled (e.g. can be ground and reconstituted in a slurry to again form a foam product).

### Examples

Materials:

Mountain Pine beetle (MPB) kill samples were acquired from crown land adjacent to Dahl Lake provincial park, Fraser-Fort George, BC, Canada, at a global positioning system (GPS) coordinate of 53°47′47.0″N 123°18′10.0″W. A dead standing pine tree was chosen and chopped down into small pieces of 4 inch length. Ample sample was collected (around 20 kg) and was transported to a laboratory. Polyvinyl alcohol (PVA, 87-90% hydrolyzed, molecular weight 30,000-70,000), and sodium dodecyl sulfate (SDS)(purity 298.5%) were purchased from Sigma Aldrich. All water used was Millipore Milli-Q grade distilled deionized water (18.2 MΩ·cm resistivity).

Methods:

Wood Processing: MPB kill samples were firstly cut into cylinders using a hand saw to approximately 2 inch in length. The cut cylinders were chipped into smaller pieces using an axe. These wood chips were further milled using a knife mill (SM100 Comfort, Retsch) until fibres could pass through a 2 mm mesh sieve. Milled fibres were obtained in a broad distribution of particle sizes, with aspect ratio in the range of 1.7:1 to 11:1 (between about 0.9 mm and 4.5 mm in length, and between about 0.4 mm and 1.2 mm in diameter).

Slurry Preparation and Foaming: PVA (4 g) was solubilized in water (64 mL), under magnetic stirring. After solubilizing PVA, SDS (0.048 g) and wood fibres (12 g) were added to the PVA solution. To some of the slurries, sodium bicarbonate was added, as a flame retardant. The slurry was homogenized under magnetic stirring for 5 min. The slurry was then foamed using a homogenizer (ultra turrax T25, IKA) operating at 9000 rpm, until the foam volume remained constant (for about 7 min).

Drying: After foaming, aliquots of the wet foam were placed in 10 silicon molds (33 mm×33 mm, 15 mm height, =17 mL) and were oven-dried at 70 degrees Celsius overnight. The resulting product is referred to hereinafter as a “forest residue based rigid foam product”.

Apparent Density Determination: The weight of the forest residue based rigid foam products was measured, and the volume was calculated from the dimensions determined using a caliper. Apparent density (ρₐₚₚ) is the ratio between the mass and the total volume of the foam, including solid phase and voids.

Mechanical Testing: Forest residue based rigid foam products were compressed at 1.3 mm/min, according to the ASTM D695 standard. Compressive testing was carried out using a universal testing machine (model 5969, Instron). Three specimens were used to evaluate the mechanical properties of forest residue based rigid foam products. For comparisons, samples of expanded polystyrene (EPS) foam (ρₐₚₚ=0.018 g/cm³) were compressed at the same conditions.

Thermal Conductivity: The thermal conductivity of the forest residue based rigid foam products was determined using a thermal conductivity analyser (C-Therm, TCi). The heat capacity of the forest residue based rigid foam products was determined by Differential Scanning Calorimetry (DSC, Q20, TA Instruments), according to the ASTM standard E1269-11.

Fire Retardancy: The forest residue based rigid foam products, both with and without the flame retardant, were cut into thin strips of 1 cm width and 10 cm length.

Samples were then held at the edge with a clamp. The free end of the sample was exposed to butane flame for approximately 5 seconds. The flame was removed and the sample was observed for flame extinguishing characteristics.

Recyclability: The forest residue based rigid foam products were ground in a mixer and the resultant powder was reformulated with water and additives to re-form a foam.

Results:

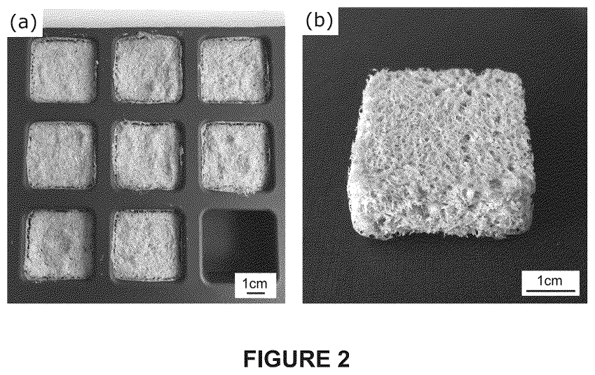

FIG. 2 shows photographs of the forest residue based rigid foam product. Panel (a) is a photograph of the forest residue based rigid foam products after drying in a silicone mold. Panel 2(b) is a close up photograph showing the foam structure.

The apparent density of the forest residue based rigid foam product was 0.089 (0.003) g/cm³.

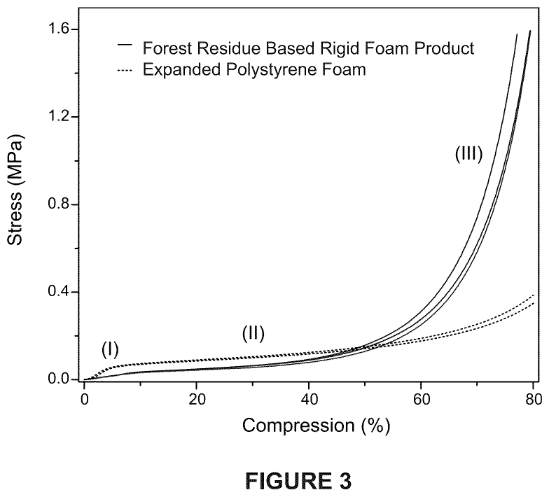

FIG. 3 is a stress-strain diagram of the forest residue based rigid foam products and the EPS foam under compressive strain with three compressive regimes: (I) elastic, (II) plateau, and (III) densification. The analysis can be divided into two regions. Below 50% compression test (elastic and plateau regions), the forest residue based rigid foam products are stiffer and are able to incur more stress compared to EPS foam. Beyond 50% compression, EPS foams show considerable densification, which is absent in the forest residue based rigid foam products.

The heat capacity of the forest residue based rigid foam products was determined to be 1416 J/kg×K. The thermal conductivity (known as k-value or lambda-value) was determined to be 0.042 (stdev: 0.002) W/m×K. The thickness of the sample was 13.90 mm.

The flame retardant changed the characteristic forest residue based rigid foam products. Samples of foams without flame retardant continued to burn, meanwhile samples with flame retardant showed self extinguishing characteristics. This shows that foams with flame retardant properties were achieved.

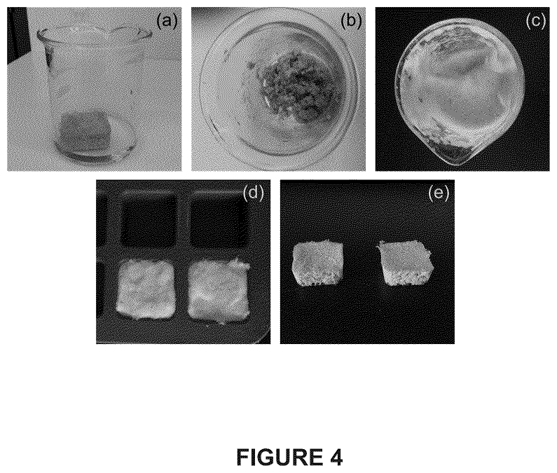

FIG. 4 shows photographs of the recyclability tests. Panel (a) is a photograph of a forest residue based rigid foam product on the water surface. Panel (b) is a photograph of a slurry made after rewetting the forest residue based rigid foam product. Panel (c) shows a wet foam of the rewetted slurry. Panel (d) is a photograph of the foamed rewetted slurry in a silicone mold. Panel (e) is a photograph of recycled forest residue based rigid foam products foams after drying.

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

1. A process for manufacturing a rigid foam product, comprising:
a. processing a forest residue to obtain fibers having a mesh size of at most 5 mm mesh and an aspect ratio of between about 0.5:1 and 20:1;
b. preparing a slurry comprising the fibers, water, a foaming agent, and a polymer additive;
c. foaming the slurry to yield a wet foam; and
d. drying the wet foam to yield a rigid foam product.

2. The process of claim 1, wherein the rigid foam product comprises at least about 60 wt % of the fibers.

3. (canceled)

4. The process of claim 1, wherein the size of the fibers is between 1 mm mesh and 5 mm mesh, and wherein the aspect ratio of the fibers is between about 1.5:1 and 12:1.

5. (canceled)

6. (canceled)

7. (canceled)

8. The process of claim 1, wherein step a. comprises grinding the forest residue with at least one of a knife mill, a hammer mill, and a ball mill.

9. The process of claim 1, wherein step b. comprises homogenizing the slurry.

10. The process of claim 1, wherein step c. comprises incorporating air into the slurry.

11. (canceled)

12. The process of claim 1, wherein step d. comprises heating the wet foam to between about 60 degrees Celsius and about 90 degrees Celsius, draining the wet foam, transferring the wet foam into a mold and drying the wet foam in the mold, and/or spraying the wet foam onto a surface and drying the wet foam on the surface.

13. (canceled)

14. (canceled)

15. (canceled)

16. The process of claim 1, wherein the slurry further comprises a fire retardant.

17. (canceled)

18. The process of claim 1, wherein the polymer additive comprises at least one of a strengthening agent and a thickening agent.

19. (canceled)

20. The process of claim 1, wherein the slurry further comprises a bio-particle additive comprising at least one of micro fibrillated cellulose (MFC), cellulose nanofibers (CNFs), cellulose nanocrystals (CNCs), and lignin particles.

21. The process of claim 1, wherein the forest residue comprises at least one of pine beetle kill, forest trimmings, and ash borer kills.

22. The process of claim 1, wherein the foaming agent comprises at least one of sodium dodecyl sulfate, sodium stearate, dioctyl sodium sulfosuccinate (DOSS), alkyl-aryl ether phosphates, and linear alkylbenzene sulfonates (LABs).

23. The process of claim 1, wherein the rigid foam product is at least one of a thermal insulation board and a sprayed foam.

24. (canceled)

25. A rigid foam product, comprising:
a. at least about 60 wt % of a forest residue fibers having a mesh size of at most 5 mm mesh and an aspect ratio of between about 0.5:1 and 20:1;
b. between about 0.1 wt % and about 15 wt % of a polymer additive; and
c. between about 0.1 wt % and about 7.5 wt % of a foaming agent;
wherein the rigid foam product has a density of between about 40 and about 150 kg/m³.

26. (canceled)

27. (canceled)

28. (canceled)

29. The rigid foam product of claim 25, further comprising between about 0.1 wt % and about 10 wt % of a fire retardant.

30. (canceled)

31. (canceled)

32. The rigid foam product of claim 25, wherein the polymer additive comprises at least one of a strengthening agent and a thickening agent.

33. (canceled)

34. The rigid foam product of claim 25, further comprising at least one of micro fibrillated cellulose (MFC), cellulose nanofibers (CNFs), cellulose nanocrystals (CNCs), and lignin particles.

35. The rigid foam product of claim 14, wherein the forest residue fibers comprise at least one of pine beetle kill, forest trimmings, and ash borer kills

36. The rigid foam product of claim 25, wherein the foaming agent comprises at least one of sodium dodecyl sulfate, sodium stearate, dioctyl sodium sulfosuccinate (DOSS), alkyl-aryl ether phosphates, and linear alkylbenzene sulfonates (LABs).

37. (canceled)

38. (canceled)

39. (canceled)

40. (canceled)

41. The rigid foam product of claim 25, wherein the rigid foam product is a sprayed foam or a thermal insulation board.

42. (canceled)
